(19) United States
(12) Patent Application Publication
(10) Pub. No.: US 2014/0316600 A1
(43) Pub. Date: Oct. 23, 2014

(54) ELECTRICITY CONTROL SYSTEM, APPARATUS AND METHOD

(71) Applicant: NATION-E LTD, Herzliyya (IL)

(72) Inventor: Daniel Jammer, Herzliyya (IL)

(21) Appl. No.: 14/355,582

(22) PCT Filed: Nov. 1, 2012
(86) PCT No.: PCT/IB2012/056097

§ 371 Date: May 1, 2014

Related U.S. Application Data
(60) Provisional application No. 61/553,974, filed on Nov. 1, 2011.

(51) Int. Cl. G05F 1/66

(52) U.S. Cl. CPC G05F 1/66
USPC 700/297

(57) ABSTRACT

A system, apparatus and method for controlled provision of electricity through an integrated dual system, in which a first part of the dual system both provides electricity and charges the second part of the dual system.

### FIELD OF THE INVENTION

The present invention relates generally to cost-effective electricity control systems and apparatuses, and more specifically to control and backup electricity production methods, apparatuses and systems.

### BACKGROUND OF THE INVENTION

There is growing concern that the Western world uses too much energy and is too energy-dependent on a small number of sometimes hostile, oil, gas and coal producing countries. However, the population distribution requires both public and private transportation systems. Additionally, grid electricity is largely produced from coal and other fossil fuels. Households tend to use electricity at certain peak hours and to use little or no electricity at off-peak hours. Moreover, there are often emergency conditions under which there is a power outage, such as usage beyond availability, floods, storms, wars and the like.

There is therefore a need to provide systems for peak shaving of “over-use” of electricity at certain hours and to replace that use of the electricity at off-peak hours.

There is a further urgent need to provide control and backup electricity production methods and systems.

### SUMMARY OF THE INVENTION

The background art does not teach or suggest a system, method or apparatus for providing control of provision of electricity. The background art also does not teach or suggest a system, method or apparatus for back-up provision of electricity.

According to at least some embodiments of the present invention, there is provided a system, apparatus and method for controlled provision of electricity through an integrated dual system, in which a first part of the dual system both provides electricity and charges the second part of the dual system. The second part of the dual system is an energy storage apparatus which rapidly switches to electricity provision in the absence of such provision from the first part of the dual system. The first part of the dual system may optionally provide “mains” or AC (alternating current) electricity, for example, although other types of electricity may optionally be provided, additionally or alternatively, including but not limited to diesel, biofuel or other liquid fuel generated electricity; renewable non-fuel generated electricity, including but not limited to electricity generated through solar, wind, waves, geothermal and the like; or any other suitable electricity generating mechanism. The energy storage apparatus preferably comprises a battery with a “smart” control system, which is able to control both charging of the battery from the first part of the dual system and is also able to control discharge of electricity from the battery in the absence of electricity being supplied from the first part of the dual system.

According to at least some embodiments of the present invention, for an implementation with mains or grid electricity, the system comprises at least the following connection: at least one grid to battery connection, which would be present inside a building such as a house or other dwelling, a commercial building, or a hospital, prison or other institution, such as a 230V AC/DC to a 5 kW connection.

According to at least some embodiments, the smart control system may optionally direct the battery to supply electricity in case of an unplanned shutoff of electricity from the first part of the dual system, for example optionally in case of failure of the grid to supply electricity. Alternatively or additionally, according to at least some embodiments, the smart control system may optionally direct the battery to supply electricity at times of high rates or tariffs, and may then block provision of electricity from the grid, even in the absence of grid failure. As described in greater detail below, in at least some embodiments, the smart control system may optionally comprise a communication device and may receive a command from a remote location, such as a power plant for example, to block provision of electricity from the grid, again in the absence of grid failure, and to direct the battery to supply electricity.

Additionally, according to an embodiment of the present invention, the first part of the system further includes at least one of a wind turbine, a hydrogenerator for generating electricity through water, a geothermal installation and a solar photovoltaic panel.

As described in greater detail below, according to at least some embodiments, the smart control system may also optionally direct the battery to supply electricity back to the first part of the system, for example back to the grid, also optionally if directed to do so by a remote location.

Optionally the energy storage apparatus comprises a D.C. (direct current) to A.C. converter for any of the above embodiments.

According to at least some embodiments, there is provided a method for rapidly detecting an alarm in a local installation, the local installation being connected to an electricity grid, the method comprising: providing a battery, smart control system and smart meter at the local installation, wherein the smart meter monitors power consumption to the electricity grid and wherein the smart control system monitors the battery and the smart meter; monitoring power consumption to the electricity grid by the smart meter; monitoring the battery and the smart meter by the smart control system; detecting anomalous behavior by the smart control system; and issuing an alarm by the smart control system.

Optionally, wherein said detecting said anomalous behavior comprises receiving information regarding said anomalous behavior from at least one of the battery and the smart meter. Optionally the method further comprises providing a plurality of sensors, wherein said detecting said anomalous behavior comprises receiving information regarding said anomalous behavior from at least one sensor.

Optionally said detecting said anomalous behavior further comprises detecting a plurality of data parameters outside of normal ranges from a plurality of sources by the smart control system; and according to a combination of the number of sources, the number of parameters and the extent to which the parameters fall outside of normal ranges, determining that anomalous behavior has occurred by the smart control system.

Optionally the method further comprises providing a remote control center; receiving said alarm by said remote control center; and determining an extent of said alarm by the remote control center.

Optionally said determining said extent of said alarm comprises receiving alarm information from a plurality of local installations; and at least determining a geographical area related to locations of said plurality of local installations.

Optionally said determining said extent of said alarm further comprises determining an amount of anomalous behavior at each of said plurality of local installations.

According to at least some embodiments, there is provided a method for rapidly detecting an alarm in a system, the system comprising a plurality of local installations in communication with a remote control center, the local installations being connected to an electricity grid, the method comprising: providing a battery, smart control system and smart meter at the local installations, wherein the smart meter monitors power consumption to the electricity grid and wherein the smart control system monitors the battery and the smart meter; monitoring power consumption to the electricity grid by the smart meter; monitoring the battery and the smart meter by the smart control system; detecting anomalous behavior by the smart control system; transmitting information regarding said anomalous behavior to the remote control center; and determining the alarm according to said information.

Optionally said determining the alarm comprises determining an extent of the alarm.

Optionally said determining said extent of said alarm comprises receiving alarm information from a plurality of local installations; and at least determining a geographical area related to locations of said plurality of local installations.

Optionally said determining said extent of said alarm further comprises determining an amount of anomalous behavior at each of said plurality of local installations.

According to at least some embodiments, there is provided a method for managing energy consumption at a local installation, the local installation connected to an electricity grid, the method comprising providing a local installation battery, an electric vehicle battery, a smart meter and a smart control system at the local installation, wherein the smart meter monitors power consumption to the electricity grid and the electric vehicle battery, and wherein the smart control system monitors the local installation battery and the smart meter; determining a tariff for electricity charges from the electricity grid; determining a power level at the local installation battery and the electric vehicle battery; feeding power from the electric vehicle battery or from the local installation battery if the tariff is over a predetermined level; and otherwise feeding power from the grid to the electric vehicle battery, the local installation battery or a combination thereof.

According to at least some embodiments, there is provided a method for supplying power through a plurality of power sources to a plurality of power receivers, each power receiver having access to a steady power source, the method comprising: providing an energy storage apparatus at each power receiver, comprising a battery, a smart control system and a communication device; providing a remote control center comprising a remote control center communication device in communication with said energy storage apparatus communication device; analyzing a status of said energy storage apparatus and said steady power source by said smart control system; initiating communication between said energy storage apparatus and said remote control center through said respective communication devices; transmitting said status information from said smart control system to said remote control center; and receiving a command from said remote control center according to said status information.

According to at least some embodiments, there is provided a system for performing load balancing across an AC power grid, said AC power grid supplying power to a plurality of power receivers, the system comprising: an energy storage apparatus at each power receiver, said energy storage apparatus comprising a communication device, a battery and a smart control system, wherein said smart control system monitors said AC power grid at said power receiver and also monitors said battery; a remote control center comprising a communication device; wherein said remote control center determines a status of said AC power grid and also a status of a connection to said AC power grid at each power receiver, and a status of said battery at each power receiver, by obtaining status information from said smart control system at each power receiver, and wherein said remote control center analyzes said status information to determine how to balance a power load across said AC power grid, and instructs at least one smart control system to reduce power consumption from said AC power grid, and instructs at least one smart control system to increase power consumption from said AC power grid, thereby performing load balancing across said AC power grid.

According to at least some embodiments, there is provided a method for power smoothing at a power receiver, the power receiver being sensitive to both power fluctuations and also to a minimum energy threshold, the method comprising: initially providing power to the power receiver from a steady power source; detecting fluctuation in power levels beyond a certain tolerance by a smart control system, wherein said smart control system monitors power provided to the power receiver from said steady power source; and initiating provision of power from an energy storage apparatus by said steady power source to achieve power smoothing.

Optionally said power receiver is selected from the group consisting of a building, a dwelling, a commercial building, a factory, a refinery, a hospital, prison or other institution.

Optionally said steady power source comprises an electrical power grid.

Optionally said steady power source provides at least 50% of the power for the power receiver.

Optionally the smart control system controls the amount of power being supplied by the energy storage apparatus in order to maintain the power received by the power receiver within the desired tolerance.

Optionally the method further comprises determining whether the energy storage apparatus absorbs excess power or provides additional power by the smart control system.

Optionally power provided by said steady power source has power spikes, the method further comprising causing the energy storage apparatus to absorb the extra power by the smart control system.

Optionally the method further comprises causing a further power source to provide power to the power receiver by the smart control system.

Optionally said further power source comprises one or more of a fuel based generator, wind power, hydro power or solar power.

As described herein, a computer may optionally comprise one or more of a computing environment, a computing device, a computer, a Personal Computer (PC), a server computer, a client/server system, a mobile computer, a portable computer, a laptop computer, a notebook computer, a tablet computer, a network of multiple interconnected computers or servers or devices, a smart phone, a cellular telephone, a radio communication device featuring a processor or the like.

For example, a computer may optionally include a processor, an input unit, an output unit, a memory and storage unit, a display and a communication unit, and optionally one or more other suitable hardware components and/or software components.

The processor includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. The processor executes instructions, for example, of an Operating System (OS) and of one or more software applications.

The input unit, if present, includes, for example, a keyboard, a keypad, a mouse, a touch-pad, a track-ball, a stylus, a microphone, or other suitable pointing device or input device. The output unit includes, for example, a monitor, a screen, a Cathode Ray Tube (CRT) display unit, a Liquid Crystal Display (LCD) display unit, a plasma display unit, one or more audio speakers or earphones, or other suitable output devices.

The memory unit includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units.

The storage unit includes, for example, a hard disk drive, a floppy disk drive, a Compact Disk (CD) drive, a CD-ROM drive, a Digital Versatile Disk (DVD) drive, or other suitable removable or non-removable storage units. The memory unit and/or storage unit, for example, store data.

Any communication unit described herein may optionally include, for example, a wired or wireless Network Interface Card (NIC), a wired or wireless modem, a wired or wireless receiver and/or transmitter, a wired or wireless transmitter-receiver and/or transceiver, a Radio Frequency (RF) communication unit or transceiver, or other units able to transmit and/or receive signals, blocks, frames, transmission streams, packets, messages and/or data. Optionally, the communication unit includes, or is associated with, one or more antennas, for example, a dipole antenna, a monopole antenna, an omni-directional antenna, an end fed antenna, a circularly polarized antenna, a micro-strip antenna, a diversity antenna, or the like.

In some embodiments, some or all of the components of such a computer may optionally be enclosed in a common housing or packaging, and may be interconnected or coupled or operably associated using one or more wired or wireless links. In other embodiments, components of such a computer may optionally be distributed among multiple or separate devices or locations, may be implemented using a client/server configuration, may communicate using remote access methods, or the like.

As described herein, the term “electric vehicle” may optionally be selected from the group consisting of an electric land vehicle, and electric water vehicle and an electric air vehicle, which can fly.

The term “electric land vehicle” is meant herein to broadly include any vehicle which travels on land. Some non-limiting examples of electric land vehicles include an electric bicycle, an electric motorbike, an electric trolley, an electric car, an electric truck, an electric tram; an electric train, an electric emergency vehicle and an electric army vehicle.

The term “electric water vehicle” is meant herein to broadly include any vehicle which travels on/in water. Some non-limiting examples of electric water vehicles include an electric bike, an electric boat, an electric yacht, an electric ship, an electric hovercraft, an electric hydrofoil, an electric submarine, an electric emergency water vehicle and an electric army water vehicle.

The term “electric air vehicle” is meant herein to broadly include any vehicle which travels in the air, typically by flight. Some non-limiting examples of electric air vehicles include an electric glider, an electric airplane, an electric helicopter, an electric airship, an electric spaceship or shuttle, an electric rocket, an electric emergency air vehicle and an electric army air vehicle.

### BRIEF DESCRIPTION OF THE DRAWINGS

The invention will now be described in connection with certain preferred embodiments with reference to the following illustrative figures so that it may be more fully understood. With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic block diagram showing a system for controlling and backup electricity provision, in accordance with an embodiment of the present invention;

FIGS. 2A-2D show schematic block diagrams of the energy storage apparatus in four different modes of operation, according to at least some embodiments of the present invention;

FIG. 3 provides an exemplary, illustrative method according to at least some embodiments of the present invention for controlling a plurality of energy storage apparatuses 106 by remote control center 124;

FIG. 4 shows an exemplary, illustrative method according to at least some embodiments of the present invention for rapid decision making, particularly with regard to alarms, in the system of FIG. 1;

FIG. 5 is a schematic block diagram of a household and electric vehicle charging system, in accordance with an embodiment of the present invention;

FIG. 6 is a simplified flow chart of a method for peak shaving in an electricity grid system, in accordance with an embodiment of the present invention; and

FIG. 7 relates to an exemplary, illustrative non-limiting method according to at least some embodiments of the present invention for providing smoothed power through the action of smart control system 116.

In all the figures similar reference numerals identify similar parts.

### DETAILED DESCRIPTION OF PREFERRED EMBODIMENTS

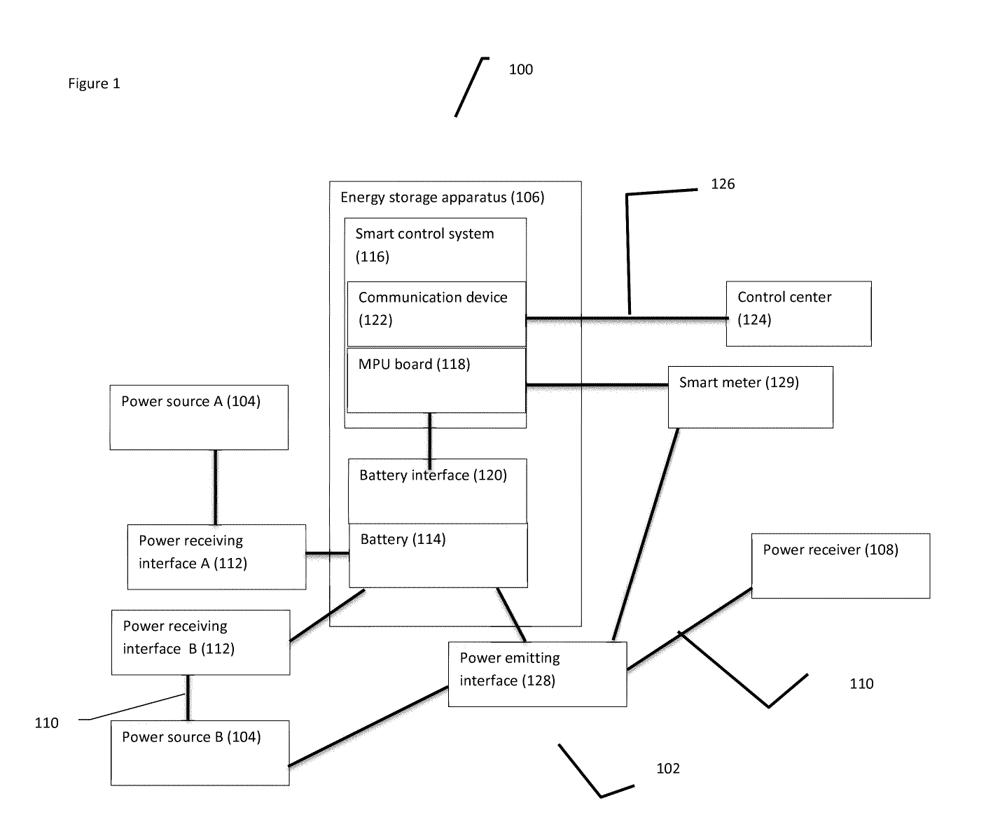

According to at least some embodiments of the present invention, there is provided a smart energy management system and method, which may include various local components for local installation (for example and without limitation, at a house or other building as described in greater detail below) and also a remote management center. FIGS. 1-4 generally relate to such a smart energy management system and method.

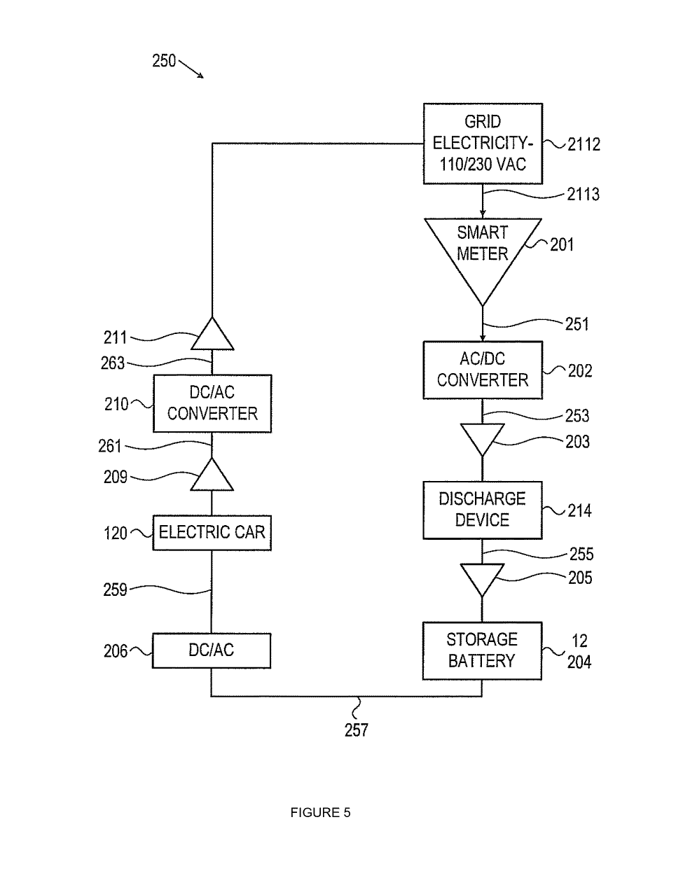

According to at least some other embodiments of the present invention, there is provided an energy consumption and provision smoothing system and method, which is described in greater detail below with regard to the various local components, as well as optional remote system components. FIGS. 5-7 generally relate to such an energy consumption and provision smoothing system and method.

However, optionally the various embodiments and subembodiments of the below Figures may also optionally be combined, both within and between the smart energy management system and method, and the energy consumption and provision smoothing system and method. Some non-limiting examples of such combinations are provided below, but these are only examples and any other combination may also be considered to fall within the scope of the present invention.

In the detailed description, numerous specific details are set forth in order to provide a thorough understanding of the invention. However, it will be understood by those skilled in the art that these are specific embodiments and that the present invention may be practiced also in different ways that embody the characterizing features of the invention as described and claimed herein.

The present invention will be more fully understood from the following detailed description of the preferred embodiments thereof, taken together with the drawings.

Reference is now made to FIG. 1, which is a schematic block diagram showing a system for controlling and backup electricity provision, in accordance with an embodiment of the present invention. As shown a system 100 features a dual energy system 102, comprising at least one power source 104 as a first part of energy system 102 (of which a plurality of power sources A and B 104 are shown for the purpose of illustration only and without any intention of being limiting) and an energy storage apparatus 106 as a second part of energy system 102.

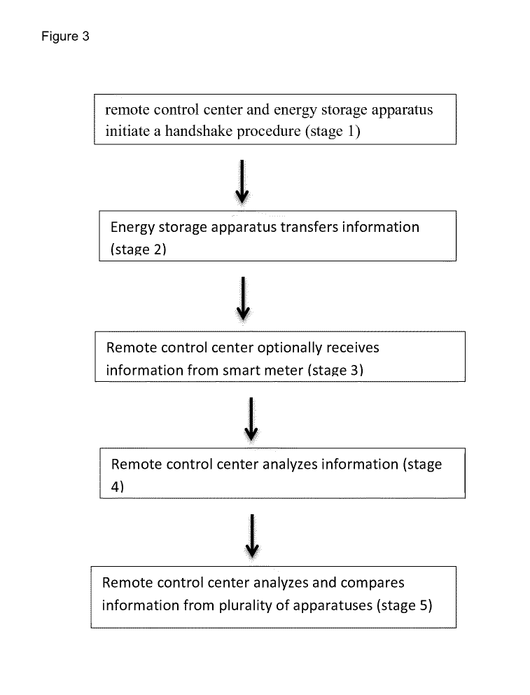

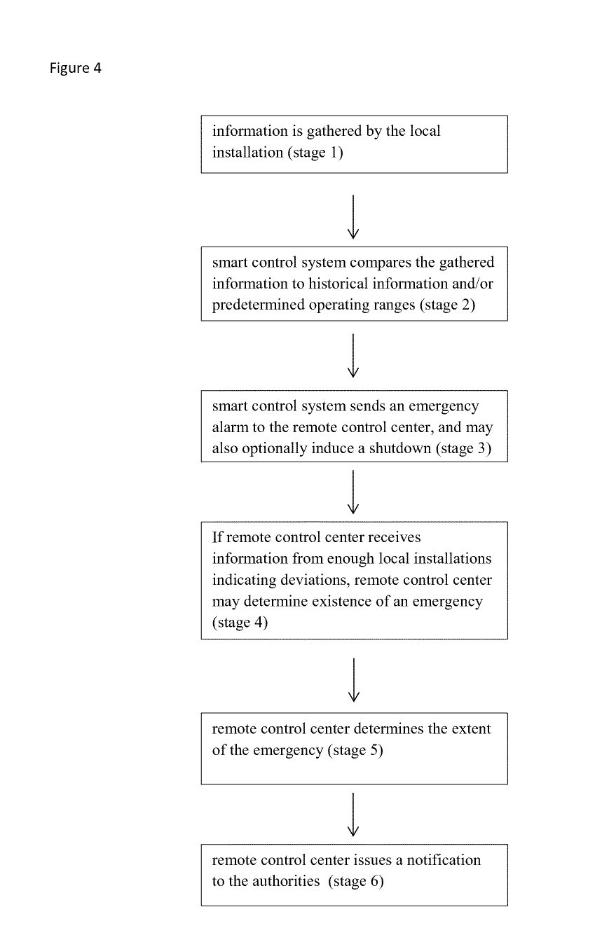

Each power source 104 is operatively connected to energy storage apparatus 106 through a power connection 110 and corresponding power receiving interface 112, of which a plurality of each (referenced in each case as A and B) are shown for the purpose of illustration only and without any intention of being limiting. Each power receiving interface 112 may optionally comprise any necessary conversion devices or any other required circuitry (not shown, see FIGS. 3 and 4).

Each power receiving interface 112 is in turn operatively connected to a battery 114, which may optionally comprise a plurality of energy cells (not shown, see FIGS. 3 and 4). Battery 114 may optionally comprise any suitable type of battery for example and without limitation, a battery from Kokam Battery (Kokam Company, Korea). For a house, battery 114 preferably comprises a suitable amount to support the electrical requirements of a house, such as for example and without limitation 16.5 kW. Battery 114 is optionally and preferably controlled by a smart control system 116, which comprises at least a MPU (master power unit) board 118. MPU board 118 optionally comprises a plurality of control components, more preferably including a processor for executing one or more commands. MPU board 118 is preferably able to command battery 114, for example through a battery interface 120.

MPU board 118 is optionally and preferably able to detect available power and the status of battery 114, as described in greater detail below. MPU board 118 is also optionally and preferably able to detect available power from power source B 104.

Optionally and preferably, MPU board 118 is in communication with a smart meter 129, which may optionally be co-localized with energy storage apparatus 106 or alternatively may optionally be in remote communication with energy storage apparatus 106 (not shown). Smart meter 129 is also optionally able to detect available power from power source B 104, either directly (not shown) or through communication with MPU board 118. Furthermore, smart meter 129 may also optionally control local provision of power as described in greater detail below; smart meter 129 may also optionally receive external commands regarding such control, as described in greater detail below. Smart meter 129 is also optionally able to control supply of power from an electric car (not shown), for example optionally to power receiver 108 and/or to power source B 104 (particularly if implemented as the electrical grid, as described in greater detail below).

Some non-limiting examples of smart meters include (as examples only, without intending to provide a closed list):

a) MeterUS, Newer retrofit US domestic digital electricity meter Elster REX with 900 MHz mesh network topology for automatic meter reading and “EnergyAxis” time-of-use metering. Each local mesh networked smart meter has a hub such as this Elster A3 Type A30 which interfaces 900 MHZ smart meters to the metering automation server via landline).

b) Single phase—smart electricity meter (PCR421) The PCR421 in a powerful single-phase Smart Electricity Meter built for residential applications. The meter combines advanced metering technology, state-of-the-art communications, and internal relay unit, all integrated and sealed in a single housing. The integrated solution allows Powercom Ltd. (Building 268, Kibbutz Ramat Hakovesh, Israel 44930) to offer a real time AMI solution with two way communication. It enables reading, controlling and interfacing other sensors or meters. Using open protocols enables the PCR421 collect information from any 3rd party meter/sensor manufacturers. The meter supports renewable Energy sources (PV and Wind). The meter is approved according to IEC62052-11, IEC 62053-21 and ISO 9001.

c) Polyphase smart electricity meter (PCR423) The PCR423 Series Polyphase Smart Electricity Meter is an intelligent node of Smart Grid, designed to meet the needs of residential, commercial and industrial three phase energy consumers. PCR423 integrates multi-communication and control methods. It performs precise energy measurement, remote control, load detection, the user application control, Multi utility for water and gas meters, User energy consumption display and management functions. Volt/VAR real time measurement (available from Zest Energy. 47 Galaxy Avenue Linbro Business Park Johannesburg South Africa, Private Bag X10011 Sandton 2146 South Africa).

Smart control system 116 may also optionally comprise a communication device 122, which is preferably in communication with a remote control center 124 through a remote communication channel 126. Communication device 122 may optionally include, for example, a wired or wireless Network Interface Card (NIC), a wired or wireless modem, a wired or wireless receiver and/or transmitter, a wired or wireless transmitter-receiver and/or transceiver, a Radio Frequency (RF) communication unit or transceiver, or other units able to transmit and/or receive signals, blocks, frames, transmission streams, packets, messages and/or data. Optionally, communication device 122 includes, or is associated with, one or more antennas, for example, a dipole antenna, a monopole antenna, an omni-directional antenna, an end fed antenna, a circularly polarized antenna, a micro-strip antenna, a diversity antenna, or the like.

Remote communication channel 126 may optionally comprise a public network, such as the internet, and may include any type of wired or wireless communication network capable of coupling together computing nodes. This includes, but is not limited to, a local area network, a wide area network, or a combination of networks. In some embodiments, remote communication channel 126 comprises a wireless data network including: a cellular network, a WiMAX network, an EV-DO network, an RTT network, a Flash-OFDM network, an iBurst network, a HSPA network, an EDGE network, a GPRS network, a GPS satellite network, a Wi-Fi network, a UTMS network, and/or any combination of the aforesaid networks, which may optionally be private or public networks.

Remote control center 124 may optionally receive information regarding the status and condition of energy storage apparatus 106 and/or any power source 104 through communication device 122 and remote communication channel 126. Remote control center 124 may also optionally issue one or more commands to smart control system 116, for example regarding the operation of battery 114. MPU board 118 may then optionally issue one or more commands to battery 114 as described in greater detail below.

Remote control center 124 may also optionally issue one or more commands to smart meter 129, either directly (not shown) or through MPU board 118, also as described in greater detail below. In any case, such commands may optionally control local provision of power, as described in greater detail below.

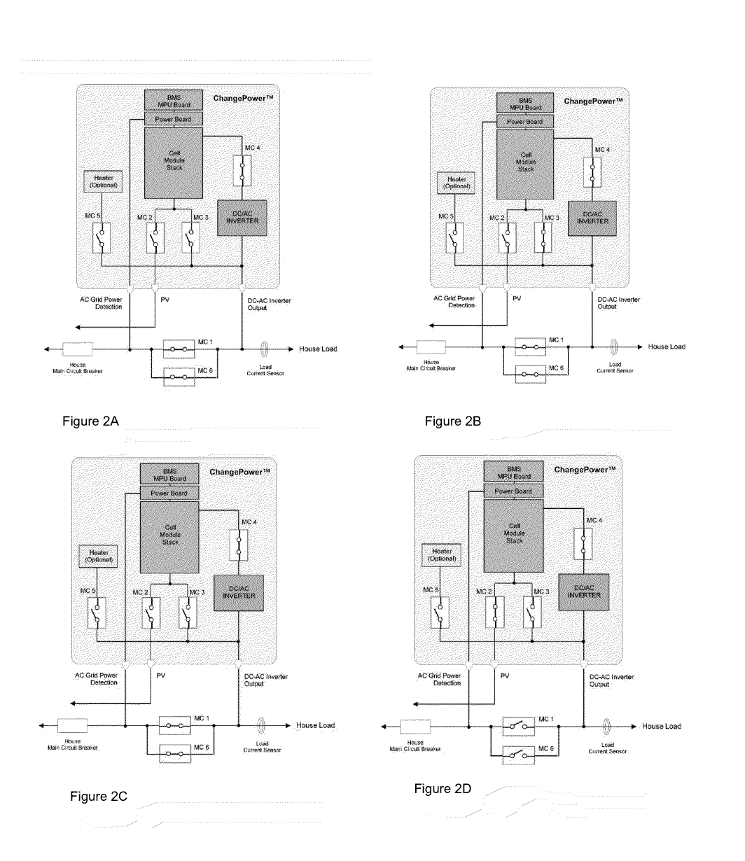

Each power source 104 supplies power to energy storage apparatus 106 but optionally not all power sources 104 supply power to a power receiver 108; as illustrated, only power source B 104 supplies power directly to power receiver 108. Power from power source B 104 is optionally and preferably provided through a power emitting interface 128, which may also optionally be the same power emitting interface 128 through which power is supplied to power receiver 108 from energy storage apparatus 106 as shown, although alternatively a different power emitting interface may be provided. A non-limiting example of a more detailed illustration of power emitting interface 128 is shown in FIG. 2. Power emitting interface 128 is preferably connected to power receiver 108 through power connection C 110 as shown.

Power receiver 108 may optionally comprise any entity requiring power, whether a building or collection of buildings, including but not limited to a house, commercial building, hospital, store, shopping center, hotel, refinery, drilling platform, factory, military base, prison or other institution; an installation requiring power, including but not limited to a refinery, a drilling platform, a boat, a plane, a factory and so forth; or an apparatus requiring power. In the illustrative embodiment shown, either power source B 104 or energy storage apparatus 106 may supply power directly to power receiver 108, while power source A 104 does not supply power directly to power receiver 108.

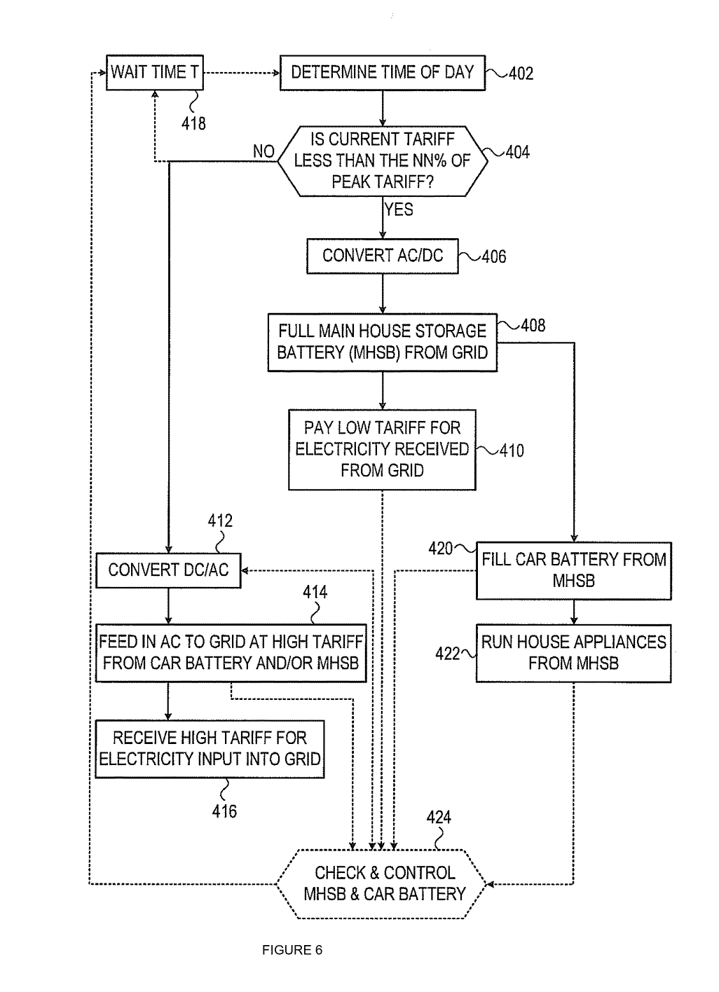

For example and without limitation, power source A 104 may optionally comprise a renewable non-fuel source of power, including but not limited to a wind turbine, a solar power installation, a hydropower installation, a geothermal installation and the like. FIG. 6 shows a more detailed version of such a power source as coupled to energy storage apparatus 106.

For example and without limitation, power source B 104 may optionally comprise grid power, power from a fuel based generator (whether diesel, “biofuel” or the like) and the like. By “grid” it is meant the electrical power grid which connects power generation plants at utilities to entities that receive power such as power receiver 108.

In some embodiments, some or all of the components of energy storage apparatus 106 may be enclosed in a common housing or packaging, and may be interconnected or coupled or operably associated using one or more wired or wireless links. In other embodiments, components of system 100 may be distributed among multiple or separate devices or locations, may be implemented using a client/server configuration, may communicate using remote access methods, or the like.

Remote control center 124 may optionally at least monitor provision of power to power receiver 108 and may also optionally control provision of power to power receiver 108. For example, remote control center 124 may optionally issue one or more commands to smart meter 129 and/or to MPU board 118, which in turn may optionally control provision of power to power receiver 108 through power emitting interface 128 for example. Other local points are also optionally possible, additionally or alternatively, for example regarding provision of power from power source A or B 104, and/or provision of power from energy storage apparatus 106 in general and battery 114 in particular.

Remote control center 124 may also optionally control the ability of energy storage apparatus 106 in general and battery 114 in particular to provide energy to power source B 104; for example if power source B 104 is the grid, then remote control center 124 may also optionally control the ability of energy storage apparatus 106 in general and battery 114 in particular to provide energy to the grid. Preferably, power source A 104 is also able to provide energy to power source B 104, but more preferably only through energy storage apparatus 106, in order to provide additional control over the energy supplied and also optionally to better control the form of that energy, for example to render the energy more suitable for the grid. FIG. 3 provides an exemplary, illustrative method according to at least some embodiments of the present invention for controlling a plurality of energy storage apparatuses 106 by remote control center 124.

For example, if power source B 104 is experiencing an overload of drawn power, remote control center 124 may optionally require power receiver 108 to obtain more or all power from energy storage apparatus 106 and/or power source A 104. Again, as noted in greater detail below, remote control center 124 may optionally and preferably control a plurality of power receivers 108 and/or energy storage apparatuses 106. Remote control center 124 may also optionally require energy storage apparatus 106 and/or power source A 104 to provide power to power source B 104. Alternatively, if power source B 104 has excess capacity, remote control center 124 may optionally require energy storage apparatus 106 to receive and store additional energy.

Smart meter 129 optionally enables power provided to power source B 104 to be sold or otherwise be provided in exchange for financial remuneration. For example, if remote control center 124 requires energy storage apparatus 106 and/or power source A 104 to provide power to power source B 104, then optionally smart meter 129 determines compensation to be provided. Smart meter 129 may also optionally control whether power receiver 108 receives power from power source A or B 104 and/or energy storage apparatus 106, for example according to tariff rates and so forth. Smart meter 129 may optionally do this independently (not shown) or in conjunction with remote control center 124.

For embodiments without smart meter 129, and optionally also for embodiments with smart meter 129, MPU board 118 is optionally and preferably able to detect available power from power source B 104. In case of an unplanned outage, reduction in electricity or reduction in the quality of supplied electricity (for example and without limitation, “spikes” or “troughs” in energy level, particularly with regard to higher than desired or permitted variability), MPU board 118 is optionally and preferably able to switch power provision for power receiver 108 from power source B 104 to energy storage apparatus 106. MPU board 118 is optionally able to control power emitting interface 128, to determine how power is supplied to power receiver 108. MPU board 118 is also optionally and preferably able to detect available power and the status of battery 114, for example to determine whether power is received from power source A 104 (optionally to supply power to battery 114).

For example and without limitation, if power receiver 108 is a home, and there is an unexpected cut in power availability or quality, then MPU board 118 is preferably able to detect this status and to quickly shift power supply from power source B 104 to energy storage apparatus 106. MPU board 118 is preferably able to do so independently of remote control center 124 and/or smart meter 129. Such a quick independent shift means that the home (power receiver 108) is able to maintain a smooth uninterrupted power supply, preferably without undesired spikes or other potentially problematic electricity delivery problems. These functions may also optionally be provided, additionally or alternatively, through smart control system 116.

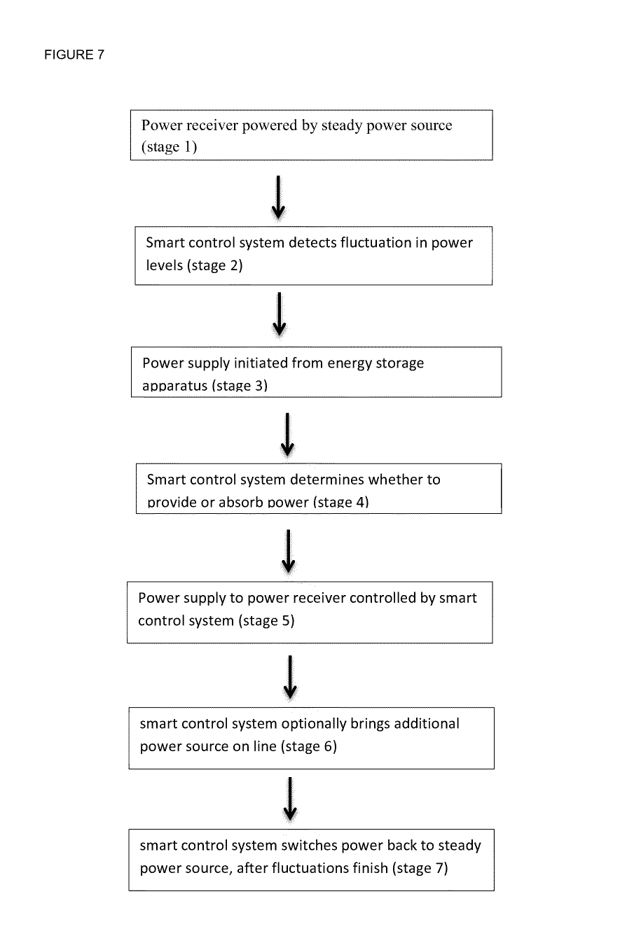

FIG. 7 relates to an exemplary, illustrative non-limiting method according to at least some embodiments of the present invention for providing smoothed power through the action of smart control system 116, as described in greater detail below.

FIGS. 2A-2D show schematic block diagrams of the energy storage apparatus in four different modes of operation, according to at least some embodiments of the present invention. FIG. 2A shows the energy storage apparatus (labeled as a “changepower” module) in discharge mode but with another power source (in this non-limiting example, the AC grid) also providing power to the power receiver (in this non-limiting example, a house). FIG. 2B shows the energy storage apparatus in charge mode, charging from power supplied by the AC grid. FIG. 2C shows the energy storage apparatus in standby mode, with the AC grid also operational. FIG. 2D shows the energy storage apparatus in discharge mode, in which it is the only power source for the house, as the AC grid is not supplying power.

Turning now to FIG. 2A, as shown the energy apparatus again features an MPU board, as well as a power board. The MPU board receives information about the AC grid, to sense whether the AC grid is capable of supplying power. As previously described, the MPU board monitors the battery and the AC grid. The power board monitors the cells of the battery, to determine their power level and to report this information to the MPU board. The battery is shown implemented as a plurality of cells, such as for example lithium ion prismatic cells (although optionally any suitable type of cell may be used) connected to a DC/AC inverter. Optionally a heater is provided as shown. The heater can also cool the cells, as it controls internal temperature of the cells. This type of battery, with heater and boards, is well known in the art and can be purchased “off the shelf”.

The energy storage apparatus optionally and preferably features a plurality of switches or “master contactors”, and more preferably features four such switches, shown as MC2-5. MC5 controls power to the heater, while MC4 controls power to the inverter. MC2 and MC3 control power transmission to and from the battery as shown (MC2 is shown as connected to “PV” which stands for a non-fuel renewable source of energy, such as a power voltaic panel for capturing solar energy for example).

The energy storage apparatus is preferably in electrical communication with the AC grid (shown as AC grid power detection) and with the electrical circuitry of the house (shown as main house circuit breaker and current load sensor). Two more switches, MC1 and MC6, complete the circuit with the energy storage apparatus.

In the discharge operational mode shown in FIG. 2A, in which switches MC2, MC3 and MC5 are closed and the remaining switches are open, the battery can supply power back to the grid. For example, the inverter supports the grid with 90% of the measured power of the home load, while preferably reserving 10% for the battery to maintain its function. However, these percentages are non-limiting examples only.

Table 1 shows the state of the switches during full output discharging and the resultant power provided.

| Contactors | State | Power line | Output power [kW] |
|---|---|---|---|
| MC1 | Close | A | 2 |
| MC6 | Close | B | 0 |
| MC2 | Close | C | = |
| MC3 | Close | D | 3.3 |
| MC4 | Close | E | 4 |

Total: 6 + 3.3

Table 1 assumes that power is available from the non-fuel renewable source of energy. However, if such power is not available, then the state of the switches and the resultant power output is as shown in Table 2. MC2 and MC3 are closed because this implementation assumes that the solar panel is not operative in FIG. 2A.

| Contactors | State | Power line | Output power [kW] |
|---|---|---|---|
| MC1 | Close | A | 0 |
| MC6 | Close | B | 0 |
| MC2 | Open | C | = |
| MC3 | Open | D | 3.3 |
| MC4 | Close | E | 4 |

Total: 4 + 3.3

Turning now to FIG. 2B, the energy storage apparatus is shown in charge mode, charging from power supplied by the AC grid. Now MC2 and MC5 are open, and the remaining switches are closed.

Turning now to FIG. 2C, the energy storage apparatus is in standby mode, with the AC grid also operational. Now switches MC2, MC3 and MC5 are open, and the remaining switches are closed.

Table 3 shows the state of the switches during standby mode and the resultant power provided.

| Contactors | State | Power line | Output power [kW] |
|---|---|---|---|
| MC1 | Close | A | 0 |
| MC6 | Close | B | 0 |
| MC2 | Open | C | = |
| MC3 | Open | D | 3.3 |
| MC4 | Open | E | 0 |

Total: 0 + 3.3

Turning now to FIG. 2D, the energy storage apparatus is shown in emergency power supply mode, in which it is the only power source for the house, as the AC grid is not supplying power. Switches MC2 and MC4 are closed, and the remaining switches are open.

Table 4 shows the state of the switches during emergency power supply mode and the resultant power provided, assuming that the renewable non-fuel source of power is available (otherwise switches MC2 and MC3 would also be open).

| Contactors | State | Power line | Output power [kW] |
|---|---|---|---|
| MC1 | Open | A | 2 |
| MC6 | Open | B | 0 |
| MC2 | Close | C | = |
| MC3 | Close | D | 0 |
| MC4 | Close | E | 4 |

Total: 6 + 0

FIG. 3 shows an exemplary, illustrative method for controlling a plurality of energy storage apparatuses by the remote control center, according to at least some embodiments of the present invention. The method may optionally be implemented with the system of FIG. 1, for example.

As shown, in stage 1, the remote control center and at least one but preferably a plurality of energy storage apparatuses initiate a handshake procedure to begin communication. Optionally, the remote control center initiates the handshake procedure, optionally and preferably with a “wake up” signal that causes the local communication device at each energy storage apparatus to become active. Alternatively, each energy storage apparatus may optionally initiate the procedure. Preferably both sides may initiate the procedure according to circumstances; for example, the remote control center may initiate the procedure in case of problems with the overall grid, while each energy storage apparatus may optionally initiate periodically and/or to inform the remote control center of any problems with power supply.

The handshake procedure preferably involves identification of each party. More preferably, each energy storage apparatus has a local address in a network of such apparatuses, thereby enabling the remote control center to identify the apparatus. Most preferably, each energy storage apparatus also features a further identifier for exchanging with the remote control center as part of a security protocol, to reduce any potential problems with “hacking” or other security breaches. Although communication is described herein with regard to a secured handshake protocol and secured communication, optionally communication may be secured or unsecured for any aspect of the present invention as described herein.

In stage 2, after the handshake process is complete, the energy storage apparatus preferably begins transferring information to the remote control center. Such information may optionally be transferred in the form of packets, with a header identifying the energy storage apparatus and optionally the type of information being transferred. Other data transfer formats may optionally alternatively be implemented. The information being transferred preferably includes status information regarding the battery, local power situation, any historical information, any emergencies or power anomalies, and so forth.

In stage 3, the remote control center optionally receives any financial information and/or reports from the smart meter, preferably through the energy storage apparatus as previously described.

In stage 4, the remote control center preferably analyzes the information from the energy storage apparatus, and if necessary sends one or more commands to adjust the functioning of the energy storage apparatus, for example to require additional power storage, to change any local parameters for switching power sources and so forth.

In stage 5, the remote control center preferably analyzes and compares information from a plurality of energy storage apparatuses. If the remote control center detects a geographically constrained anomaly or emergency, the remote control center preferably informs the necessary authorities (for example that there appears to be a power outage in a particular geographical area). Alternatively or additionally, the remote control center may attempt to reroute power or to otherwise reduce or solve the problem through communication with a plurality of energy storage apparatuses.

If the remote control center detects a diffuse or grid-wide anomaly or emergency, the remote control center may optionally attempt to solve the problem by instructing a plurality of energy storage apparatuses to provide more power to the grid, reduce power consumption from the grid or increase power consumption from the grid. Optionally a plurality of different actions may be required at different points in the grid from different energy storage apparatuses. Thus, the remote control center may optionally provide grid balancing by performing the above stages as required over a plurality of energy storage apparatuses.

FIG. 4 relates to an exemplary, illustrative method according to at least some embodiments of the present invention for rapid decision making, particularly with regard to alarms, for example with regard to the system of FIG. 1.

As previously described with regard to the method of FIG. 3, optionally the remote control center preferably analyzes and compares information from a plurality of energy storage apparatuses; if the remote control center detects a geographically constrained anomaly or emergency, the remote control center preferably informs the necessary authorities and/or may take other actions. The method described with regard to FIG. 4 provides a non-limiting example of how such a decision may be more rapidly reached with regard to functioning of the system.

In stage 1, information is gathered by the local installation, which as shown in FIG. 1 may optionally include various power receiving interfaces, a smart control system and a smart meter (as well as one or more of the other components shown; for the purpose of discussion, this method is described with regard to these specific components for the sake of clarity and without any intention of being limiting). By “local installation” it is meant any physically co-located installation, including but not limited to a house, hospital, a commercial building, a school, a prison or other institution, factory, refinery, other building or collection of buildings, a drilling platform, a military base, store, shopping center, hotel, or any satellite location.

Information may optionally be gathered by the local installation through one or more sensors, but may also be gathered by the smart control system, smart meter and so forth, for example according to information gathered by the MPU board or other local energy controllers or sensors (which may optionally include one or more of temperature sensors, water meters, gas meters and the like).

In stage 2, the smart control system compares the gathered information to historical information and/or predetermined operating ranges, in order to determine whether the gathered information indicates that the operations of the local installation are outside of one or more normal ranges.

In stage 3, if the operations of the local installation are outside of one or more normal ranges, then the smart control system sends an emergency alarm to the remote control center, and may also optionally induce a shutdown. Such a decision may optionally be reached by the smart control system according to a “majority rules” decision, in which even if the deviations are not greatly outside of normal ranges, if a sufficiently large number of the deviations are present, such as for example and without limitation a majority of the data points, then the smart control system determines that an emergency exists. Alternatively, the smart control system may optionally send the information itself, without an indication of an alarm.

In stage 4, if the remote control center receives information from a sufficiently large number of local installations indicating such deviations, then again, even if the deviations are relatively minor, the remote control center may determine the existence of an emergency. The remote control center may determine the existence of an emergency even if the local installations are not sending alarms, but only information regarding the deviations. Again optionally the remote control center may apply a “majority rules” decision.

In stage 5, the remote control center determines the extent of the emergency, according to the information received from the local installations. For example in case of an earthquake, the remote control center may optionally determine one large area that is affected, or alternatively may determine that there is an epicenter of damage, and then one or more less damaged areas. Therefore, the “extent” of the emergency may optionally relate to the geographical region that is at all affected by the emergency, and/or may also optionally relate to graded areas of damage within that geographical region.

In stage 6, the remote control center issues a notification to the authorities. In the case of a hierarchical system (not shown), multiple layers of control may optionally communicate to determine whether an emergency exists and if so, the extent of the emergency.

Turning now to FIG. 5, a simplified schematic diagram of a household and electric vehicle charging system 250 is provided, in accordance with an embodiment of the present invention.

System 250 relates to electricity flow into and out of an electricity grid 2112 to and from at least one house 10 or other local installation, as previously defined herein.

System 250 comprises at least the following connections:
a) at least one grid to battery connection 2113, such as inside a house 10, such as a 230V AC/DC to a 5 kW connection for example and without limitation;
b) at least one battery 12, found in house 10 and optionally and preferably be capable of fast charging an electric car 120 through a DC/DC connection 259 in 15 minutes or less; and
c) at least one vehicle to grid connection (V2G), optionally and preferably implemented as DC/AC and for example being capable of 3 kW transfer, shown in FIG. 5 as components AC/DC converter 210, connector 263 and smart meter 211.

System 250 optionally and preferably comprises a number of smart electricity control meters 201, 203, 205, 207, 209, 211, which may optionally be implemented as a single smart meter (not shown, see FIG. 1) and which allow the functionalities of charging the main house storage battery (MHSB) 12 and vehicle battery (VB) (not shown, see electric car 120 which includes such a vehicle battery) during the low cost tariff. This reduces the cost of charging, and allows the utility to supply more energy, and shave off the peaks, thereby feeding in the battery 12 with the most attractive tariff through the smart meter 205.

The MHSB 12 and/or the VB can be used as a UPS backup system. The MHSB 12 can further be used as a power supply to release electricity at high tariff hours, to combine cheap stored electricity for charging house and electrical automotive products (car, e-scooters etc) and emergency power supply for all the appliances within the house 10.

The stored power supply in the MHSB 12 and/or the VB may be channeled for charging appliances and electric vehicles 120 in different charging modes.

After charging the electric vehicle 120, the electric vehicle 120 becomes a V2G device (vehicle to grid device) where the stored electricity in the battery of the vehicle (VB) becomes a device to transfer energy to the grid 2112.

There is thus provided according to an embodiment of the present invention, an electric vehicle to grid (V2G) A.C. electric supply system for compensating the A.C. electric supply system, the supply system including;
a) at least one A.C./D.C. converter adapted to receive A.C. electric power from the A.C. electric supply system and to convert the A.C. electric power into D.C. power;
b) at least two batteries adapted to receive and store at least some of the D.C. power;
c) at least one electric vehicle including at least one of the at least two batteries; and
d) at least one D.C./A.C. converter adapted to receive D.C. electric power from the at least one battery in the at least one electric vehicle and to supply A.C. electric power to the A.C. electric supply system.

Additionally, according to an embodiment of the present invention, at least one of a) to d) are disposed in a building.

Furthermore, according to an embodiment of the present invention, all of a) to d) are disposed in a building.

Moreover, according to an embodiment of the present invention, the building is a residential building.

Additionally, according to an embodiment of the present invention, the at least one electric vehicle is adapted to receive D.C. electric power at a first location and to provide D.C. electric power to the at least one D.C./A.C. converter at a second location.

Further, according to an embodiment of the present invention, the at least one A.C./D.C. converter is adapted to be active at a low-tariff time of day. Yet further, according to an embodiment of the present invention, the at least one D.C./A.C. converter is adapted to be active at a high-tariff time of day.

Additionally, according to an embodiment of the present invention, the at least one of the at least two batteries is a house main storage battery. According to an additional embodiment of the present invention, the electric vehicle to grid (V2G) A.C. electric supply system further includes at least one smart power meter, adapted to control electric power flow in the system.

Additionally, according to an embodiment of the present invention, the electric vehicle to grid (V2G) A.C. electric supply system further includes at least one of a wind turbine and a solar photovoltaic panel (not shown, see FIG. 1).

Moreover, according to an embodiment of the present invention, the at least two at least two batteries are configured to effect peak shaving and load leveling in the system.

There is thus provided according to another embodiment of the present invention, an electric vehicle to grid (V2G) A.C. electric supply method for compensating the A.C. electric supply system, the supply method including;
a) converting the grid A.C. electric power from the A.C. electric supply system into D.C. electric power at off-peak time periods;
b) storing at least some of the D.C. electric power in at least one battery of an electric vehicle; and
c) converting at least some of the D.C. electric power from the at least one battery into output A.C. electric power and
d) inputting at least some of the output A.C. electric power to the A.C. electric supply system at high-tariff time periods.

Additionally, according to an embodiment of the present invention, all of steps a) to d) are performed at a first location.

Furthermore, according to an embodiment of the present invention, the inputting step is performed at a second location of the grid.

Moreover, according to an embodiment of the present invention, an electric power demand at the second location exceeds an electric power supply at the location. Additionally, according to an embodiment of the present invention, the first location is selected from a residential location and an industrial location.

Further, according to an embodiment of the present invention, the method performs at least one of the following;
i. minimizes grid electricity use;
ii. minimizes grid high peak electricity use;
iii. maximizes a low; high peak electricity use ratio;
iv. maximizes fees received for high tariff electric power input into the grid from the electric vehicle;
v. minimizes fees paid for the low tariff electric power consumption at the first location;
vi. reduces grid A.C. electric power consumption during high-tariff time periods;
vii. induces grid A.C. electric power leveling and peak shaving; and
viii. increases grid A.C. electric power consumption during the off-peak time periods.

Additionally, according to an embodiment of the present invention, the method performs all of steps i. to viii.

Moreover, according to an embodiment of the present invention, the electric vehicle to grid (V2G) A.C. electric supply method further includes
e) charging a fee to a user of a the at least one electric vehicle for charging the at least one battery; and
f) charging a fee to a user of the at least two batteries for the charging the at least two batteries step.

As is known, the ability of an electricity grid 2112 to provide electricity fluctuates according to the amount of electricity produced, the quantity used by consumers and the distribution network thereof. Thus, a power receiver, in this non-limiting example shown as a house 10, may find that the quantity of power provided fluctuates with time. During peak consumption, the full amount may not be available at the location of the house. An energy storage apparatus (shown as smart meter 201 for this non-limiting example) is constructed and configured to define the quantity of power available from the grid at any time. For example, at 2:30 am, there may be full power available, say 5 KW, so smart meter transfers 5 KW to an AC/DC converter 202. The DC output may be as is known in the art. It is then passed via a second smart meter 203 to a discharge device 214. Discharge device 214 transfers DC power via a third smart meter 205 to a main house storage battery 12 (for example implemented as shown in FIG. 1). The DC from the discharge device charges main house storage battery 12. Optionally all of these smart meters are implemented as a single smart meter, as shown with regard to FIG. 1.

At 8:30 am, there may be less power available from grid 2112. Smart meter 201, optionally in conjunction with one or more of smart meters 203, 205, 207, 209, 211, determines a low level of power available from grid 2112. Smart meter 201 activates main house storage battery 12 to transfer power via a DC/DC transformer 206 to a battery pack 128 in electric car 120 (or other electric vehicle described herein). Thereafter, electric car 120 serves as a source of AC current to grid, after conversion of its DC power of battery pack 128 into AC in a DC/AC converter 210. It should be understood that main house storage battery 12 may also receive DC power directly from a solar panel 2104 and/or from a wind turbine 2102. Additionally or alternatively, power generated from the solar heater and/or wind turbine may be converted by converter 210 or by a separate inverter (not shown) into AC power and introduced to grid 2112.

The electric car thus acts as a V2G (vehicle to grid) source of power during peak power requirements. The systems of the present invention thus enable peak shaving by using main house storage battery 12 as opposed to mains electricity during peak demand, and serve to increase use of low tariff off-peak electricity during low demand times. It should be understood that the vehicles can move from place to place and introduce electricity into a grid at any point where there is insufficient grid power.

Smart meter 201, optionally in conjunction with one or more of smart meters 203, 205, 207, 209, 211, can determine the sequence of activation and inactivation of all elements 202, 214, 204, 206, 128, 210 in system 250 to ensure at least one or more of the following:
a) low to minimal cost of electricity for house 10;
b) high to maximizing high-tariff electricity input to grid from vehicle (V2G);
c) high to maximal input to grid from electricity producing appliances in house (solar panel 2104, wind turbine 2102 or others);
d) accurate monitoring of all power inputs and outputs to grid 2112;
e) high to maximal fiscal return for house from electricity generation therein and thereby; and
f) accurate monitoring of money transfer or other financial transaction equivalents relating to all of the above.

FIG. 6 is a simplified flow chart of a method 400 for peak shaving in an electricity grid system, in accordance with an embodiment of the present invention. This method may be performed using the system of FIG. 1 for example.

In a time of day determining step 402, the time of day is determined by the electricity control flow unit. Let the time be for example 2 am. At 2 am there is no sun and there may or may not be any wind, but the tariff rate for downloading electricity is relatively cheap as this time is off-peak.

In a current tariff checking step 404, the system of FIG. 1 checks to see if the current (present) tariff is less than a predetermined percent, denoted NN %, say, for example, 50% of the peak tariff. This may be performed by the remote control center of FIG. 1.

If the current tariff is less than 50% of the peak tariff, this is considered to be “cheap electricity” and thus, system 100 decides to use this “off-peak” electricity. The decision making may be activated in practice by one or more smart meters, such as smart meter 201 (FIG. 5).

In an AC/DC conversion step 406, a converter, such as converter 202 (FIG. 5) converts AC grid electricity into DC current. This step may be performed continuously for a number of minutes or hours. Alternatively, this step may be performed intermittently or semi-continuously.

The DC electricity generated in step 406 is then used in a storage battery filling step 408 to fill the main house storage battery (MHSB). This step may be performed, according to some embodiments, directly. According to other embodiments, the DC electricity may first be introduced into a charging device 214 (FIG. 5) and thereafter pass via smart meter 205 into the MHSB.

Step 408 may be performed over a number of minutes or hours, depending on the size of the MHSB. This step may be performed continuously. Alternatively, this step may be performed intermittently or semi-continuously.

Once the MHSB is full or nearly full, the quantity of off-peak power transferred from grid 2112 is calculated by one or more of smart meters 201, 203, 205 and the payment for the off-peak power to the company owing grid 2112 is transferred in a payment step 410. The data may be conveyed to the remote control center.

In a low-tariff payment step 410, at least one of the following sub-steps are performed, for example:
a) the quantity of AC power received from the grid in step 406 is measured by the electric flow control unit smart meters 201, 203 etc;
b) the data pertaining to the quantity of AC power received is communicated via network 170 to at least one of the control center and the payment center (FIG. 1);
c) the data pertaining to the quantity of AC power received is stored locally at smart meters 201, 203, 205;
d) the data is stored remotely at the remote control center;
e) A calculation is performed by the payment center, using data relating to the time of day from step 406, the tariff for receipt of power from A/C grid at that time of day and the amount of power fed in, to determine the total charge to pay the A/C grid or electric company who owns the A/C grid. For example, if at 2 am the cost per kW·h is $0.2 and 2000 kW·h were received from the grid at 2 am, then a payment of $400 is paid to the electric company.

In parallel to payment step 408, the filled MHSB can now be used to fill car battery pack 128 of electric car/vehicle 120, in a fill car battery step 420. The step may involve passing DC current through a DC/DC transformer 206 (FIG. 5). Alternatively the DC current from the MHSB may be suitable for direct transfer to battery pack 128. According to some embodiments, this step may take place in a number of minutes, such as ten to twenty minutes.

Additionally, household appliances may also be charged from the MHSB in an optional household appliance charging step 422.

It should be understood that all of the steps of method 400 may be controlled using the smart meters 201, 203, 205, 209, 211 in FIG. 5 and that these meters are constructed and configured to check and control the levels of power in MHSB 204 and car battery pack 128. Thus the smart meters effect a continuous or semi-continuous check and control step 424 during some/all of the other steps of the method. In some cases, the meters are operative to introduce a waiting step 418 if no action is required, or if the time of day is too early or too late for activating a certain step.

Turning back to checking step 404, if the current tariff is more than NN % of the peak tariff, the system may optionally wait a predetermined period of time, such as ten minutes in an optional waiting step 418 and then return to step 402.

Alternatively, no waiting step 418 may be performed, and a DC/AC conversion step 412 may be activated. In this step, vehicle or car 120 acts as a source of power to be provided to the grid 2112 (Vehicle to Grid, or V2G). The vehicle is used as a source of DC power. Battery pack 128 provides DC power to a DC/AC converter, such as converter 210 (FIG. 5). Again, it should be noted that smart meters 209, 211 may control this process.

In an AC V2G step 414, AC power generated from the vehicle is fed via converter 210 into the grid at a time determined in step 404 to be high-tariff.

In a high tariff payment step 416, owner of house 10 and vehicle 120 receives payment for the AC power provided at the high tariff rate.

According to some embodiments, the method of this flowchart may be performed semi-continuously. During the day, in some cases, the PVs and/or wind turbines will produce most or all of the houses power requirements and may also feed in electricity to the grid.

The above method is intended and adapted to minimize the amount of electricity drawn from the grid and maximize the amount of electricity transferred to the grid, as well as to minimize the cost of the electricity drawn from the grid.

The above method is intended and adapted to maximize the fees received by the house/vehicle owner from the grid and/or electric company.

FIG. 7 relates to an exemplary, illustrative non-limiting method according to at least some embodiments of the present invention for providing smoothed power through the action of a smart control system, such as that of FIG. 1. For this non-limiting example, the power receiver is assumed to be an entity, such as a hospital, which is sensitive to both power fluctuations and also to a minimum energy threshold. Providing such smoothed power is also referred to as energy refinement.

In stage 1, the power receiver is initially under power from a “regular” or “steady” power source such as the AC grid (also referred to herein as the electrical power grid or electric grid). The exact nature of this power source is not important, except that it supplies at least 50% of the power for the power receiver.

In stage 2, a fluctuation in power levels beyond a certain tolerance (i.e.—higher or lower than a certain band of tolerated power) is detected by the smart control system.

In stage 3, the smart control system initiates power supply from the energy storage apparatus. Preferably, the smart control system is able to control the amount of power being supplied by the energy storage apparatus in order to maintain the power received by the power receiver within the desired tolerance.

In stage 4, the smart control system determines whether the energy storage apparatus should absorb excess power or provide additional power. If the steady power source is supplying too little power, then the energy storage apparatus provides additional power. If the steady power source is providing too much power, such that power spikes are occurring, the energy storage apparatus absorbs the extra power.

In stage 5, the smart control system determines whether to continue to allow the power receiver to receive power from the steady source or whether all such power should be directed to the energy storage apparatus. For example, if the steady source has too many fluctuations, the smart control system may determine that all power should be directed to the energy storage apparatus, which then supplies all power to the power receiver.

In stage 6, the smart control system optionally brings a further power source on-line, for example to prevent the energy storage apparatus from being drained. Such a further power source may optionally operate on fuel (such as a diesel or biofuel generator) or alternatively on non-fuel renewable sources (such as wind, hydro or solar power).

In stage 7, once the fluctuations in power from the steady power source are reduced such that the power supplied is again within the tolerance band, the smart control system preferably again switches the power receiver to receive power from the steady power source. Optionally, the energy storage apparatus also receives power from the steady power source, and/or from another power source, so as to recharge the power stored.

The references cited herein teach many principles that are applicable to the present invention. Therefore the full contents of these publications are incorporated by reference herein where appropriate for teachings of additional or alternative details, features and/or technical background.

It is to be understood that the invention is not limited in its application to the details set forth in the description contained herein or illustrated in the drawings. The invention is capable of other embodiments and of being practiced and carried out in various ways. Those skilled in the art will readily appreciate that various modifications and changes can be applied to the embodiments of the invention as hereinbefore described without departing from its scope, defined in and by the appended claims.

1-23. (canceled)

24. A method for power smoothing at a power receiver, the power receiver being sensitive to both power fluctuations and also to a minimum energy threshold, the method comprising: initially providing power to the power receiver from a steady power source; detecting fluctuation in power levels beyond a certain tolerance by a smart control system, wherein said smart control system monitors power provided to the power receiver from said steady power source; and initiating provision of power from an energy storage apparatus by said steady power source to achieve power smoothing.

25. The method of claim 24, wherein said steady power source comprises an electrical power grid.

26. The method of claim 25, wherein said steady power source provides at least 50% of the power for the power receiver.

27. The method of claim 26, wherein the smart control system controls the amount of power being supplied by the energy storage apparatus in order to maintain the power received by the power receiver within the desired tolerance.

28. The method of claim 27, further comprising determining whether the energy storage apparatus absorbs excess power or provides additional power by the smart control system.

29. The method of claim 28, wherein power provided by said steady power source has power spikes, the method further comprising causing the energy storage apparatus to absorb the extra power by the smart control system.

30. The method of claim 29, further comprising causing a further power source to provide power to the power receiver by the smart control system.

31. The method of claim 30, wherein said power receiver is selected from the group consisting of a building, a dwelling, a commercial building, a factory, a refinery, a hospital, prison or other institution.

32. The method of claim 31, wherein said further power source comprises one or more of a fuel based generator, wind power, hydro power or solar power.

33. The method of claim 25, further comprising providing a power receiver battery, an electric vehicle battery, and a smart meter at the power receiver, wherein the smart meter monitors power consumption from the electrical power grid and the electric vehicle battery, and wherein the smart control system monitors the power receiver battery and the smart meter; determining a tariff for electricity charges from the electrical power grid; determining a power level at the power receiver battery and the electric vehicle battery; feeding power from the electric vehicle battery or from the power receiver battery if the tariff is over a predetermined level; and otherwise feeding power from the grid to the electric vehicle battery, the power receiver battery or a combination thereof.

34. The method of claim 25, further comprising providing a smart meter and a battery at the power receiver, wherein the smart meter monitors power consumption from the electricity grid and wherein the smart control system monitors the battery and the smart meter; monitoring power consumption from the electricity grid by the smart meter; monitoring the battery and the smart meter by the smart control system; detecting anomalous behavior by the smart control system; and issuing an alarm by the smart control system.

35. The method of claim 34, wherein said detecting said anomalous behavior comprises receiving information regarding said anomalous behavior from at least one of the battery and the smart meter.

36. The method of claim 35, further comprising providing a plurality of sensors, wherein said detecting said anomalous behavior comprises receiving information regarding said anomalous behavior from at least one sensor.

37. The method of claim 36, wherein said detecting said anomalous behavior further comprises detecting a plurality of data parameters outside of normal ranges from a plurality of sources by the smart control system; and according to a combination of the number of sources, the number of parameters and the extent to which the parameters fall outside of normal ranges, determining that anomalous behavior has occurred by the smart control system.

38. The method of any of claim 37, further comprising providing a remote control center; receiving said alarm by said remote control center; and determining an extent of said alarm by the remote control center.

39. The method of claim 38, wherein said determining said extent of said alarm comprises receiving alarm information from a plurality of power receivers; and at least determining a geographical area related to locations of said plurality of power receivers.

40. The method of claim 39, wherein said determining said extent of said alarm further comprises determining an amount of anomalous behavior at each of said plurality of power receivers.

41. The method of claim 24, further comprising: providing a communication device for the energy storage apparatus; providing a remote control center comprising a remote control center communication device in communication with said energy storage apparatus communication device; analyzing a status of said energy storage apparatus and said steady power source by said smart control system; initiating communication between said energy storage apparatus and said remote control center through said respective communication devices; transmitting said status information from said smart control system to said remote control center; and receiving a command from said remote control center according to said status information.
